(19) United States
(12) Patent Application Publication
(10) Pub. No.: US 2019/0394210 A1
(43) Pub. Date: Dec. 26, 2019

(54) System for user authentication in each area

(71) Applicant: InTheCore Business Platform.Ltd, Seongnam-si (KR)

(72) Inventor: Hyun Seok Han, Seongnam-si (KR)

(21) Appl. No.: 16/545,226

(22) Filed: Aug. 20, 2019

Related U.S. Application Data
(63) Continuation of application No. PCT/KR2018/001245, filed on Jan. 29, 2018.

(30) Foreign Application Priority Data
Feb. 21, 2017 (KR) 10-2017-0022876

(51) Int. Cl. H04L 29/06; G06F 16/955; G06K 7/14; G06K 19/06

(52) U.S. Cl. CPC H04L 63/108; H04L 63/0876; G06K 19/06037; G06K 7/1417; G06F 16/9554

(57) ABSTRACT

Provided is a system for authenticating a user for each zone which approves an access to at least one user authority set to each zone. The system for authenticating a user for each zone may include at least one display device for displaying QR codes; and a server for transmitting information about the QR codes to the display devices, receiving authentication information acquired after a user terminal recognizes the QR codes, and approving the user terminal to access to the user authority during only a validity term of the authentication information.

### CROSS-REFERENCES TO RELATED APPLICATION

This application is a Bypass Continuation Application of a National Stage application of PCT/KR2018/001245 filed on 29 Jan. 2018, which claims priority to Korean Patent Application No. 10-2017-0022876 filed on 21 Feb. 2017, the contents of which are incorporated herein by reference.

### BACKGROUND OF THE INVENTION

### Field of the Invention

The present invention relates to a system for authenticating a user for each zone, and more particularly, to a system for authenticating a user for each zone in which an access to user authority is approved for each zone only for a certain period of time and a previous user may not be accessed to user authority, when a certain period of time elapses.

### Description of the Related Art

Since Internet and Internet of things are widely spread recently, a need to approve an access to user authority is highly increased only when a user places at a specific zone. In case of general user authentication, IDs and pin numbers are used to log-in. However, in this case, whether a user places at a specific zone is hardly recognized. Also, in order to specify a location of a user, use of GPS may be considered, however, is hard to specify a location inside. In addition, although use of NFC is currently developed, spread or practical use of NFC is not popular currently and a lot of smart phones does not support NFC. Accordingly, use of NFC is still not a complete alternative. Finally, use of a QR code may be used to approve user authority after the QR code is recognized by using smart phones. However, the QR code may be easily copied by a user through capturing with a camera. Also, a new QR code may need to be printed each time when a user is deauthorized and user authority is approved to another user.

For example, when a QR code is used to provide use authority for a person staying at a room of a hotel so that the person may control lighting or temperature of the room or make a payment while staying at the room, the person may keep the user authority of the room even after the person checks out and accordingly, it is inconvenient in changing a QR code each time when users check in. Also, when user authority of a room is approved by using location information of users, the user authority of the room may be disapproved when the users are out for a while.

### SUMMARY OF THE INVENTION

The present invention provides a system for authenticating a user for each zone in which an access to user authority is approved for each zone only for a certain period of time, a previous user may not be accessed to the user authority when a certain period of time elapses, and an access to the user authority is available without scanning a QR code again until the term of validity elapses after the QR code is recognized.

According to an aspect of the present invention, there is provided a system for authenticating a user for each zone which approves an access to at least one user authority set to each zone, the system including: at least one display device for displaying QR codes that correspond to the at least one user authority set to each zone; and a server for transmitting information about the QR codes to the display devices, receiving authentication information acquired after a user terminal recognizes the QR codes, and approving the user terminal to access to the user authority during only a validity term of the authentication information. The server may include a database management unit for matching and storing authority information comprising at least one user authority set to each zone and authentication information, in which a validity term is set, in database, deleting the authentication information having elapsed validity term stored in the database simultaneously with the elapse of the validity term of the authentication information, matching new authentication information to the authority information, and storing the new authentication information in the database; a QR code generation unit for displaying the QR codes comprising the authentication information stored in the database on the corresponding display devices; and a determination unit for receiving the authentication information acquired from the user terminal after the user terminal recognizes the QR codes displayed on the display devices and approving the user terminal to access to the user authority included in the authority information that corresponds to the authentication information when the received authentication information exists in the database.

When the user terminal tries to access to the user authority after the user terminal is firstly approved, the determination unit may receive the authentication information, which is already acquired from the QR code by the user terminal, and approve the user terminal to access to the user authority included in the authority information that corresponds to the authentication information when the received authentication information exists in the database.

The database management unit may match and store the authority information, the authentication information, and validity term information of the authentication information in the database and the determination unit may approve the user terminal to access to the user authority included in the authority information that corresponds to the authentication information when the received authentication information exists in the database and a validity term of the authentication information does not elapse.

According to another aspect of the present invention, there is provided a system for authenticating a user for each zone which approves an access to at least one user authority set to each zone, the system including: at least one display device for displaying QR codes that correspond to the at least one user authority set to each zone; and a server for transmitting information about the QR codes to the display devices, receiving authentication information acquired after a user terminal recognizes the QR codes, and approving the user terminal to access to the user authority during only a validity term of the authentication information. The server may include: a database management unit for matching and storing authority information including at least one user authority set to each zone, authentication information, and validity term information of the authentication information, in which a validity term is set, in database and storing new authentication information and validity term information matched to the authority information in the database when the validity term of the authentication information elapses; a QR code generation unit for displaying the QR codes comprising the authentication information stored in the database on the corresponding display devices; and a determination unit for receiving the authentication information acquired from the user terminal after the user terminal recognizes the QR codes displayed on the display devices and approving the user terminal to access to the user authority included in the authority information that corresponds to the authentication information when the received authentication information exists in the database and the validity term of the authentication information does not elapse.

When the user terminal tries to access to the user authority after the user terminal is firstly approved, the determination unit may receive the authentication information, which is already acquired from the QR code by the user terminal, and approve the user terminal to access to the user authority included in the authority information that corresponds to the authentication information when the received authentication information exists in the database and the validity term of the authentication information does not elapse.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual diagram of a system for authenticating a user for each zone;

FIG. 2 is a block diagram of the system for authenticating a user of FIG. 1;

FIG. 3 is an example showing information stored in database of FIG. 2;

FIG. 4 is an example showing information partially changed in the database of FIG. 3;

FIG. 5 is an example showing information added to the database of FIG. 3;

FIG. 6 is a flowchart illustrating a method of authenticating a user by using the system for authenticating a user for each zone of FIG. 1 according to an embodiment of the present invention;

FIG. 7 is a flowchart illustrating a method of authenticating a user after user authentication is firstly approved as shown in FIG. 6;

FIG. 8 is a flowchart illustrating a method of authenticating a user by using the system for authenticating a user for each zone of FIG. 1 according to another embodiment of the present invention; and

FIG. 9 is a flowchart illustrating a method of authenticating a user after user authentication is firstly approved as shown in FIG. 8.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

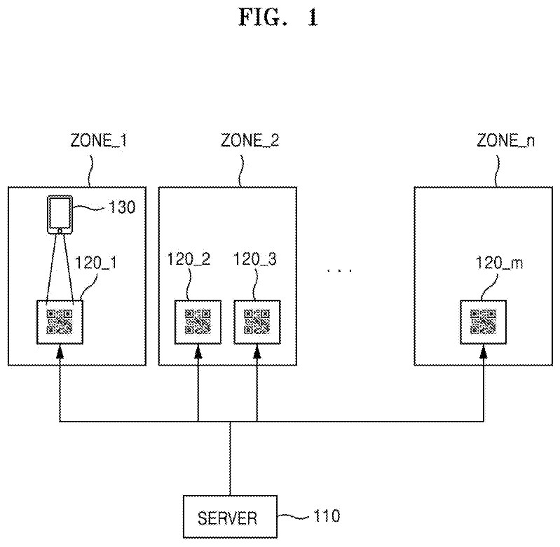

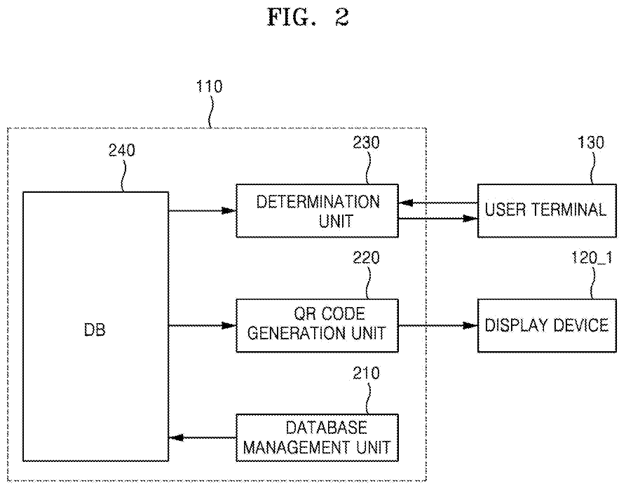

FIG. 1 is a conceptual diagram of a system for authenticating a user for each zone and FIG. 2 is a block diagram of the system for authenticating a user of FIG. 1.

Referring to FIGS. 1 and 2, at least one user authority is set to each zone ZONE_1, ZONE_2, . . . , and ZONE_n. For example, if each zone is regarded as a room of a hotel, user authority to control lighting of the zone ZONE_1 is set in connection with the zone ZONE_1 and user authority to control lighting and temperature of the zone ZONE_2 is set in connection with the zone ZONE_2. As such, at least one or more user authority is set to correspond to each zone. When user authentication described below is approved, access to user authority set to each zone may be available.

Display devices 120_1, 120_2, 120_3, . . . , 120_m may exist in each zone. The display devices may be placed in the inside or at the outside of each zone. For example, when each zone is a room of a hotel, the display device may be placed in the inside of the room or at a front desk, which is at the outside of the room.

A QR code may be displayed in each display device in order to access to user authority set to each zone. A server 110 may control the QR code to be displayed in the corresponding display device and generate the QR code to be sent to the corresponding display device. Also, when the server 110 transmits information requested to generate the QR code to the display device, the display device may generate its own QR code. The number of display devices installed in each zone is not limited to one and if needed, a plurality of display devices may be installed in each zone. For example, when the user authority set to the zone ZONE_2 includes user authority to control lighting, user authority to control temperature, and user authority to make a payment, a QR code relating to the user authority to control lighting and temperature may be displayed in the display device 120_2 and a QR code relating to the user authority to make a payment may be displayed in the display device 120_3.

The server 110 may include a database management unit 210, a QR code generation unit 220, a determination unit 230, and a database 240. The server 110 may be embodied by a memory device and a microprocessor or a plurality of microprocessors. The database management unit 210, QR code generation unit 220, and determination unit 230 may be embodied by a computer program running in a microprocessor or respective microprocessors. The database 240 may include at least one of authority information, authentication information, validity term information, display device information and zone information. The authority information includes information of at least one user authority set to each zone and may be in a form of a code or a key. For example, the authority information may be stored in the database 240 in a form of a secret key so that the authority information may not be exposed to the outside. The authentication information may be matched with the authority information and stored in the database 240. A validity term may be set to the authentication information. For example, the authentication information may be one-to-one matched with the authority information and stored in the database 240 in a form of a public key. The authentication information may be information included in a QR code displayed in a corresponding device from the display devices above. The validity term information is information relating to a validity term of the authentication information and may be stored in the database 240 in a form of a code. The display device information may be information about a display device to which a QR code including the authentication information corresponding to the authority information is displayed. The display device information may be matched with each authority information and may be information about a display device where a QR code including the authentication information corresponding to the authority information is to be displayed. The zone information may be information about a zone corresponding to the authority information.

The database management unit 210 may manage information stored in the database 240. That is, the database management unit 210 may store at least one of authority information, authentication information, validity term information, display device information, and zone information in the database 240 for each zone. Also, when the validity term of the authentication information elapses, the database management unit 210 may change and store at least one of the authentication information and the validity term information in the database 240 or may store at least one of new authentication information and validity term information in the database 240. That is, the database management unit 210 may delete the authentication information simultaneously with the elapse of the validity term and store new authentication information in the database 240 or the database management unit 210 may store new authentication information and new validity term information in the database 240. The database management unit 210 may store new authentication information simultaneously with the deletion of the authentication information or may store new authentication information after a certain period of time elapses after the deletion of the authentication information. For example, when the zone is a room of a hotel, the database management unit 210 may not store the new authentication information or the new validity term information in the database 240 and wait until a user of the room is newly checked-in after a previous user is checked-out. Also, the database management unit 210 may not delete the authentication information and the validity term information simultaneously with the elapse of the validity term and may store new authentication information and new validity term information in the database 240. In each case, operations of the determination unit 230 may vary and will be described in more detail below.

In addition, when the database management unit 210 receives an authentication information change signal used to change authentication information regardless of the elapse of the validity term of the authentication information, the database management unit 210 may delete or change at least one of the authentication information and the validity term information and store the deleted or changed authentication information and the validity term information, in response to the authentication information change signal. Also, the database management unit 210 may store at least one of new authentication information and new validity term information in the database 240. That is, the authentication information change signal may be received in the server 110 through a management server or an input means having an authority to change authentication information. When the authentication information change signal is received, the database management unit 210 may delete at least one of the existing authentication information and validity term information regardless of the elapse of the validity term of the authentication information or may store at least one of new authentication information and validity term information in the database 240.

The QR code generation unit 220 may control and display a QR code on a corresponding display device by using the authentication information stored in the database 240. As described above, the QR code generation unit 220 may generate a QR code and transmit the generated QR code to a corresponding display device. Also, the QR code generation unit 220 may transmit the authentication information to a corresponding display device so that a QR code may be generated from the corresponding display device. In another example, the QR code generation unit 220 may control and display a QR code on a corresponding display device by using the authentication information and the validity term information stored in the database 240. As described above, the QR code generation unit 220 may generate a QR code and transmit the generated QR code to a corresponding display device. Also, the QR code generation unit 220 may transmit the authentication information and the validity term information to a corresponding display device so that a QR code may be generated from the corresponding display device.

Hereinafter, operations of the determination unit 230 will be described by classifying the operations into cases where authentication information, in which the validity term elapses, is stored in the database 240 and where authentication information is not stored in the database 240.

As in a first embodiment, a case where a server 110 deletes the authentication information, in which the validity term elapses, in the database 240 simultaneously with the elapse of the validity term and stores new authentication information in the database 240 will be described. In this case, the authentication information, in which the validity term does not elapse, is only stored in the database 240. Accordingly, the authentication may be only stored in the database 240 and validity term information about the authentication information may also be stored in the database 240. In addition, the QR code may include both the authentication information and the validity term information and may only include the authentication information. That is, since the authentication information, in which the validity term does not elapse, is only stored in the database 240, the validity term information may not be included in the QR code.

Firstly, a case where the authentication information is only included in the QR code is described. When a user terminal 130 recognizes a QR code displayed on a display device 120_1 and acquires authentication information included in the QR code, the determination unit 230 may receive the authentication information acquired from the user terminal 130. For convenience of description, FIG. 2 illustrates the display device 120_1, however, the determination unit 230 may be operated as in the same manner with the other display devices 120_2, 120_3, . . . , or 120_m in FIG. 1. When the determination unit 230 receives the authentication information, the determination unit 230 may compare the received authentication information with the authentication information stored in the database 240. When the authentication information exists in the database 240, the determination unit 230 may approve the user terminal 130 to access to user authority included in the authority information which corresponds to the authentication information. If the authentication information does not exist in the database 240, the determination unit 230 may not approve the user terminal to access to user authority. In this case, in order to tighten up security of user authentication, the determination unit 230 may further determine whether the present time is applicable to validity term information, which corresponds to the authentication information existing in the database 240. As such, since the authentication information stored in the database 240 and the validity term information are both identified, security of user authentication may be tightened up.

After the user terminal 130 is firstly approved as described above, if the user terminal 130 tries to access to the user authority, the user terminal 130 may access to the user authority without recognizing the QR code again. That is, if the user terminal 130 tries to access to the approved user authority after the user terminal 130 is firstly approved, the determination unit 230 receives the authentication information, which is already acquired from the QR code by the user terminal 130. When the received authentication information corresponds to authentication information matched to the authority information including the recognized user authority, an access to the user authority may be approved. That is, in the present embodiment, since authentication information having elapsed validity term is deleted from database and only valid authentication information is stored in the database, the determination unit 230 may approve an access to the user authority, if the authentication information received from the user terminal 130 is stored in the database 240. The authentication information acquired from the QR code may be stored in a memory or a temporary memory of the user terminal 130. Also, when the user terminal 130 firstly approves, the received authentication information is stored in the server 110 along with identification information of the user terminal 130. Then, the identification information of the user terminal 130 is only received from the server 110, as long as new authentication information is not transmitted from the user terminal 130, and the authentication information stored in the server 110 may be used. When the user terminal 130 tries to access to the user authority after the first approval, the user terminal 130 may transmit the authentication information to the server 110 while requiring an access to the user authority. Also, when the user terminal 130 requests an access to the user authority, the authentication information is requested from the server 110 to the user terminal 130 and the authentication information may be transmitted to the server 110 according to the request of the user terminal 130.

Next, a case where the authentication information and the validity term information are both included in the QR code is described. In this case, the determination unit 230 may determine whether to approve an access to the user authority by using both authentication information and validity term information. That is, when the authentication information is stored in the database 240 and the present time is applicable to the validity term information, the determination unit 230 may approve an access to the user authority. If the authentication information is not stored in the database 240 or the present time is not applicable to the validity term information, even if the authentication information is stored in the database 240, the determination unit 230 may disapprove an access to the user authority. In this case, the server 110 compares the received validity term information with the validity term information stored in the database 240 to identify whether they correspond to each other and thereby, security of user authentication may be tightened up.

After the user terminal 130 is firstly approved as described above, if the user terminal 130 tries to access to the user authority, the user terminal 130 may access to the user authority without recognizing the QR code again. That is, if the user terminal 130 tries to access to the approved user authority after the user terminal 130 is firstly approved, the determination unit 230 receives the authentication information and the validity term information, which are already acquired from the QR code by the user terminal 130. When the authentication information is stored in the database 240 and the present time is applicable to the validity term information, the determination unit 230 may approve an access to the user authority. Also, in this case, the server 110 compares the received validity term information with the validity term information stored in the database 240 to identify whether they correspond to each other and thereby, security of user authentication may be tightened up. When the user terminal 130 tries to access to the user authority after the first approval, the user terminal 130 may transmit the authentication information and the validity term information to the server 110 while requiring an access to the user authority. Also, when the user terminal 130 requests an access to the user authority, the authentication information and the validity term information are requested from the server 110 to the user terminal 130 and the authentication information and the validity term information may be transmitted to the server 110 according to the request of the user terminal 130.

As in a second embodiment, a case where the server 110 does not delete authentication information, in which the validity term elapses, in the database 240 simultaneously with the elapse of the validity term and stores new authentication information and validity term information in the database 240 will be described. In this case, the authentication information and the validity term information may be both included in the QR code or only the authentication information may be included in the QR code.

Firstly, when only authentication information is included in the QR code, information received from the user terminal 130 to the determination unit 230 only includes the authentication information. Accordingly, when authentication information corresponding to the received authentication information exists in the database 240 and the present time is applicable to the validity term information of the authentication information stored in the database 240, the determination unit 230 may approve an access to user authority. If the authentication information is not stored in the database 240 or the present time is not applicable to the validity term information, even if the authentication information is stored in the database 240, the determination unit 230 may disapprove an access to the user authority.

After the user terminal 130 is firstly approved as described above, if the user terminal 130 tries to access to the user authority, the user terminal 130 may access to the user authority without recognizing the QR code again. That is, if the user terminal 130 tries to access to the approved user authority after the user terminal 130 is firstly approved, the determination unit 230 receives the authentication information, which is already acquired from the QR code by the user terminal 130. When authentication information corresponding to the received authentication information exists in the database 240 and the present time is applicable to the validity term information of the authentication information stored in the database 240, the determination unit 230 may approve an access to user authority. When the user terminal 130 tries to access to the user authority after the first approval, the user terminal 130 may transmit the authentication information to the server 110 while requiring an access to the user authority. Also, when the user terminal 130 requests an access to the user authority, the authentication information is requested from the server 110 to the user terminal 130 and the authentication information may be transmitted to the server 110 according to the request of the user terminal 130.

Next, when the authentication information and the validity term information are both included in the QR code, information received from the user terminal 130 to the determination unit 230 includes both authentication information and validity term information. Accordingly, when authentication information is stored in the database 240 and the present time is applicable to the validity term information, the determination unit 230 may approve an access to user authority. If the authentication information is not stored in the database 240 or the present time is not applicable to the validity term information, even if the authentication information is stored in the database 240, the determination unit 230 may disapprove an access to the user authority. In this case, the server 110 compares the received validity term information with the validity term information stored in the database 240 to identify whether they correspond to each other and thereby, security of user authentication may be tightened up.

After the user terminal 130 is firstly approved as described above, if the user terminal 130 tries to access to the user authority, the user terminal 130 may access to the user authority without recognizing the QR code again. That is, if the user terminal 130 tries to access to the approved user authority after the user terminal 130 is firstly approved, the determination unit 230 receives the authentication information and the validity term information, which are already acquired from the QR code by the user terminal 130. When the authentication information is stored in the database 240 and the present time is applicable to the validity term information, the determination unit 230 may approve an access to the user authority. Also, in this case, the server 110 compares the received validity term information with the validity term information stored in the database 240 to identify whether they correspond to each other and thereby, security of user authentication may be tightened up. When the user terminal 130 tries to access to the user authority after the first approval, the user terminal 130 may transmit the authentication information and the validity term information to the server 110 while requiring an access to the user authority. Also, when the user terminal 130 requests an access to the user authority, the authentication information and the validity term information are requested from the server 110 to the user terminal 130 and the authentication information and the validity term information may be transmitted to the server 110 according to the request of the user terminal 130.

According to the operations in various embodiments described above, when an access to the user authority is approved, the server 110 may access to a web page used to access to the user authority through the user terminal 130. For example, when an access to the user authority is approved, the server 110 may allow a web page used to access to the user authority to be displayed on a screen of the user terminal 130. Allowing an access to a web page is only to lessen inconvenience of a user from installing an application and the present invention is not restricted to access to a web page. When an access to the user authority is approved as described above, the user authority may be accessed through a corresponding application.

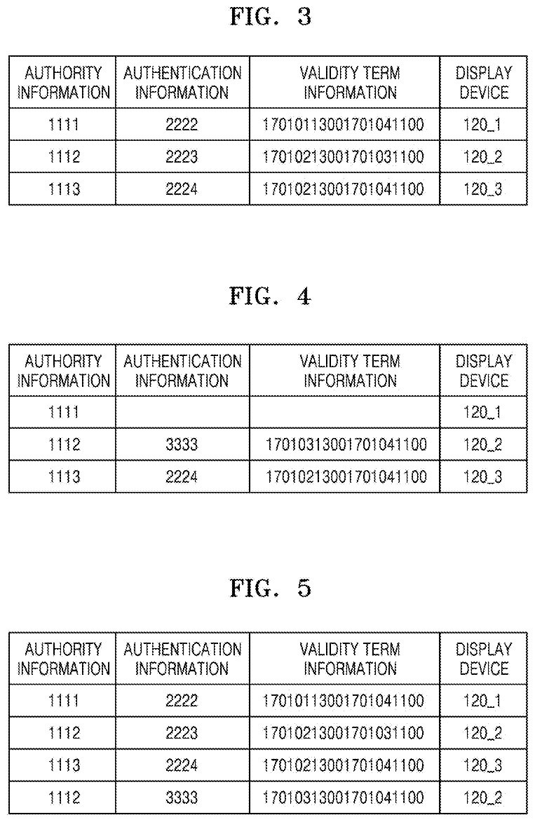

FIG. 3 is an example showing information stored in the database 240 of FIG. 2, FIG. 4 is an example showing information partially changed in the database 240 of FIG. 3, and FIG. 5 is an example showing information added to the database 240 of FIG. 3.

Referring to FIGS. 1 through 3, the database 240 of FIG. 3 includes authority information, authentication information, and validity term information for each zone. It is assumed that authority information 1112 set to the zone ZONE_2 is the authority to control lighting of the zone ZONE_2. Also, it is assumed that the authority information 1112 is matched with authentication information 2223 and the validity term is set from 13:00 on Jan. 2, 2017 to 11:00 on Jan. 3, 2017.

In this case, the QR code generation unit 220 may generate a QR code including the authentication information 2223 and display the QR code on the corresponding display device 120_2. When the user terminal 130 recognizes the QR code displayed on the display device 120_2 and acquires the authentication information 2223, the server 110 may receive the authentication information 2223 from the user terminal 130. In this case, when the received authentication information 2223 exists in the database 240 and the present time is within the validity term, the server 110 may approve the user terminal 130 of the authority to control lighting of the zone ZONE_2.

When the QR code generation unit 220 generates the QR code including the authentication information 2223 and the validity term information 17010213001701031100 and displays the QR code on the display device 120_2, the server 110 may receive the authentication information 2223 and the validity term information 17010213001701031100 from the user terminal 130. In this case, when the received authentication information 2223 exists in the database 240 and the present time is within the validity term, the server 110 may approve the user terminal 130 of the authority to control lighting of the zone ZONE_2.

FIG. 4 is an example showing that the validity term of the authentication information 2223 elapses after 11:00 on Jan. 3, 2017 so that the authentication information 2223 having elapsed validity term is deleted and new authentication information 3333 is stored in the database 240.

Referring to FIGS. 1 through 4, after the validity term of the authentication information 2223 elapses, the database management unit 210 may change the authentication information 2223 to the authentication information 3333 and the validity term information 17010213001701031100 to validity term information 17010313001701041100. For convenience of description, FIG. 4 illustrates that the authentication information and the validity term information are both changed. However, as described above, the authentication information, in which the validity term remains, is only stored in the database 240 of FIG. 4 and thus, the authentication information may be stored in the database without storing the validity term information. In this case, the database management unit 210 may only delete or store the authentication without managing the validity term information. Since the authentication information is changed from 2222 to 3333, the QR code generation unit 220 may generate a QR code including the authentication information 3333 instead of the existing QR code displayed on the corresponding display device 120_2 and display the newly generated QR code on the corresponding display device 120_2. When the user terminal 130 recognizes the QR code displayed on the display device 120_2 and acquires the authentication information 3333, the server 110 may receive the authentication information 3333 from the user terminal 130. In this case, when the received authentication information 3333 exists in the database 240 and the present time is within the validity term, the server 110 may approve the user terminal 130 of the authority to control lighting of the zone ZONE_2. When the user terminal 130, which acquires the existing authentication information 2223 at present condition, tries to acquire the user authority corresponding to the authority information 1112 by using the existing authentication information 2223, the determination unit 230 may disapprove the user authority since the received authentication information 2223 does not exist in the database 240.

When the QR code generation unit 220 generates the QR code including the authentication information 3333 and the validity term information 17010313001701041100 and displays the QR code on the display device 120_2, the server 110 may receive the authentication information 3333 and the validity term information 17010313001701041100 from the user terminal 130. In this case, when the received authentication information 3333 exists in the database 240 and the present time is within the validity term, the server 110 may approve the user terminal 130 of the authority to control lighting of the zone ZONE_2. In the same manner, when the user terminal 130, which acquires the existing authentication information 2223 and the validity term information 17010213001701031100 at present condition, tries to acquire the user authority corresponding to the authority information 1112 by using the existing authentication information 2223, the determination unit 230 may disapprove the user authority since the received authentication information 2223 does not exist in the database 240 and the present time does not correspond to the validity term.

In addition, FIG. 4 illustrates that an authentication information change signal used to change authentication information 2222 corresponding to authority information 1111 is received. That is, if it is assumed that the authentication information change signal includes information about deleting of the authentication information 2222 corresponding to the authority information 1111, the database management unit 210 may delete the authentication information 2222 corresponding to the authority information 1111 and may not store matched authentication information. In this case, any user may access to the user authority corresponding to the authority information 1111. After this, when an access to the user authority corresponding to the authority information 1111 is to be approved, the server 110 receives the authentication information change signal and the database management unit 210 may store new authentication information corresponding to the authority information 1111 in response to the authentication information change signal.

FIG. 5 is an example showing that the validity term of the authentication information 2223 elapses after 11:00 on Jan. 3, 2017 so that the authentication information 2223 having elapsed validity term and the validity term information 17010213001701031100 are not deleted and new authentication information 3333 and the validity term information 17010313001701041100 are added in the database 240.

Referring to FIGS. 1 through 5, after the validity term of the authentication information 2223 elapses, the database management unit 210 may not delete authentication information 2223 and the validity term information 17010213001701031100 and store the authentication information 3333 and the validity term information 17010313001701041100 after being matched with the authority information 1112 in the database 240. In this case, the QR code generation unit 220 may generate a QR code including the authentication information 3333 instead of the existing QR code displayed on the display device 120_2 and display the newly generated QR code on the display device 120_2. When the user terminal 130 recognizes the QR code displayed on the display device 120_2 and acquires the authentication information 3333, the server 110 may receive the authentication information 3333 from the user terminal 130. In this case, when the received authentication information 3333 exists in the database 240 and the present time is within the validity term, the server 110 may approve the user terminal 130 of the authority to control lighting of the zone ZONE_2. When the user terminal 130, which acquires the existing authentication information 2223 at present condition, tries to acquire the user authority corresponding to the authority information 1112 by using the existing authentication information 2223, the determination unit 230 may disapprove the user authority since the present time does not correspond to the validity term, though the received authentication information 2223 exists in the database 240.

When the QR code generation unit 220 generates the QR code including the authentication information 3333 and the validity term information 17010313001701041100 and displays the QR code on the display device 120_2, the server 110 may receive the authentication information 3333 and the validity term information 17010313001701041100 from the user terminal 130. In this case, when the received authentication information 3333 exists in the database 240 and the present time is within the validity term, the server 110 may approve the user terminal 130 of the authority to control lighting of the zone ZONE_2. In the same manner, when the user terminal 130, which acquires the existing authentication information 2223 and the validity term information 17010213001701031100 at present condition, tries to acquire the user authority corresponding to the authority information 1112 by using the existing authentication information 2223, the determination unit 230 may disapprove the user authority since the present time does not correspond to the validity term, though the received authentication information 2223 exists in the database 240.

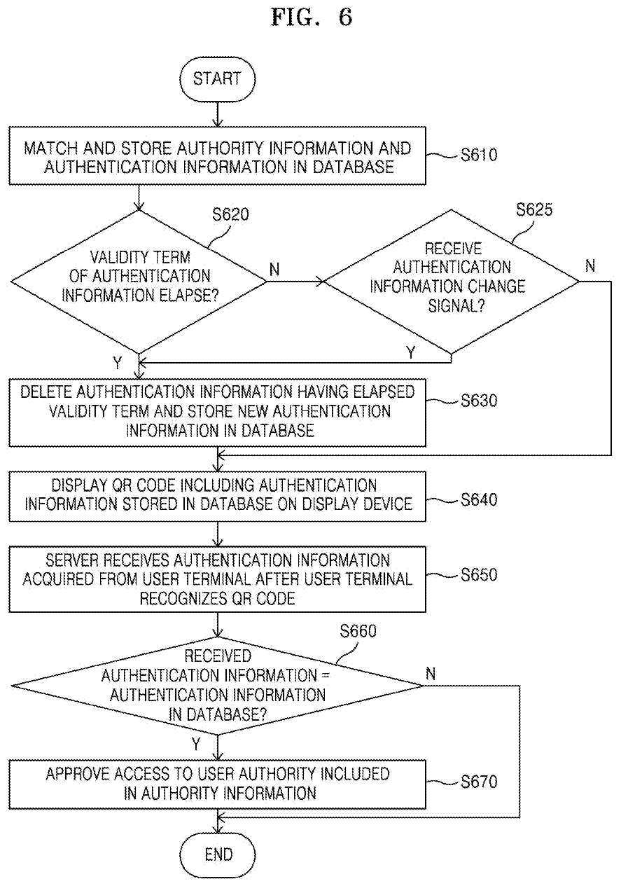

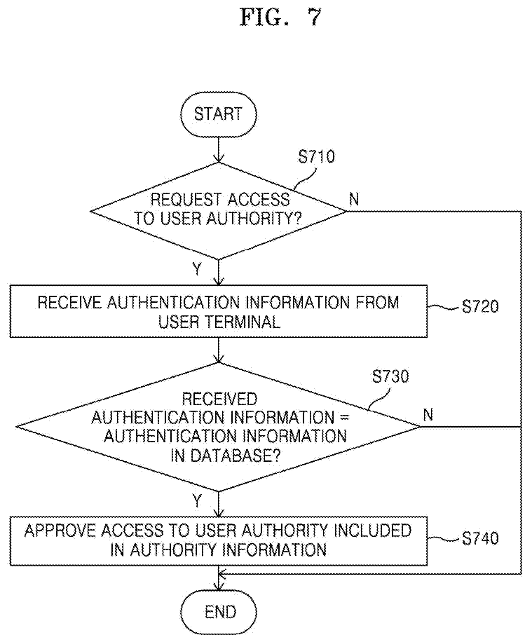

FIG. 6 is a flowchart illustrating a method of authenticating a user by using the system for authenticating a user for each zone of FIG. 1 and FIG. 7 is a flowchart illustrating a method of authenticating a user after user authentication is firstly approved as shown in FIG. 6.

Referring to FIGS. 1 through 7, the database management unit 210 may match and store the authority information including at least one user authority stored in each zone and the authentication information, to which the validity terms is set, in the database 240, in operation S610. Then, the database management unit 210 determines whether the validity term of the authentication information elapses in operation S620. When the validity term of the authentication information elapses, the elapsed authentication information is deleted, new authentication information is matched to the authority information, and the new authentication information may be stored in the database 240, in operation S630. The new authentication information may include information about new validity term. That is, only valid authentication information, in which the validity term does not elapse, may be stored in the database 240. For example, when the validity term of the authentication information 2222 matched to the authority information 1112 expires as in FIG. 3, the authentication information 2222 matched to the authority information 1112 may be deleted and the new authentication information 3333 may be matched to the authority information 1112 and stored in the database 240 as in FIG. 4. When the server 110 receives the authentication information change signal from a manager server even if the validity term of the authentication information does not elapse in operation S620, the database management unit 210 may perform operation S630. That is, the authentication information change signal is used for a manager to enforcedly change the authentication information and thereby, the database management unit 210 changes the authentication information regardless of the validity term. The server 110 may receive the authentication information change signal as information to change the authentication information having elapsed validity term to new authentication information. In this case, the database management unit 210 may perform operation S630 in response to the authentication information change signal so that the new authentication information may be matched to the authority information and stored in the database 240. When the new authentication information change signal is received even if the validity term elapses in operation S620, operation S630 may be performed, as operation S630 is performed regardless of the validity term.

The QR code generation unit 220 may display the QR code including the authentication information stored in the database 240 on the corresponding display device, in operation S640. For example, the database 240 may store information about the display devices each corresponding to the authority information in the database 240 as illustrated in FIGS. 3 through 5. In FIGS. 3 through 5, the QR code including the authentication information matched to authority information 1111 may be displayed on the display device 120_1 and the QR code including the authentication information matched to the authority information 1112 may be displayed on the display device 120_2. When the authentication information 2222 matched to the authority information 1112 is changed to the authentication information 3333, the QR code generation unit 220 may generate the QR code including the authentication information 3333 and display the QR code on the corresponding display device 120_2.

When the user terminal 130 recognizes the QR code displayed on the display device 120_2 and acquires the authentication information, the acquired authentication information is transmitted to the server 110 and the server 110 may receive the acquired authentication information, in operation S650. The determination unit 230 of the server 110 may determine whether the received authentication information exists in the database 240, that is, whether the received authentication information is identical with the authentication information stored in the database 240, in operation S660. When the authentication information that is identical with the received authentication information is stored in the database 240, the determination unit 230 may approve the user terminal 130 to access to the user authority included in the authority information corresponding to the authentication information, in operation S670. When the authentication information that is identical with the received authentication information is not stored in the database 240, the determination unit 230 may disapprove the user terminal 130 to access to the user authority included in the authority information corresponding to the authentication information.

In FIG. 6, since only valid authentication information, in which the validity term remains, is stored in the database 240, determination on the validity term is not needed. However, in order to tighten up security, the authentication information may be compared and the elapse of the validity tern of the authentication information may be determined.

After the user terminal 130 is firstly approved in FIG. 6, approval may be determined by using the acquired authentication information without recognizing the QR code by the user terminal 130 as in FIG. 7. The determination unit 230 may determine whether the user terminal 130 is to access to the user authority after the user terminal 130 is firstly approved, in operation S710. For example, when the user terminal 130 tries to again to a web page used to access to the user authority after user authentication is approved, a request to access to the web page may be a user authority use request. As such, if an access to the user authority is requested, the determination unit 230 may receive the authentication information, which is previously acquired from the user terminal 130, from the user terminal 130, in operation S720. Then, the determination unit 230 determines whether the received authentication information exists in the database 240, in operation S730, and if it is determined that the received authentication information exists in the database 240, approves the user terminal 130 to access to the user authority, in operation S740.

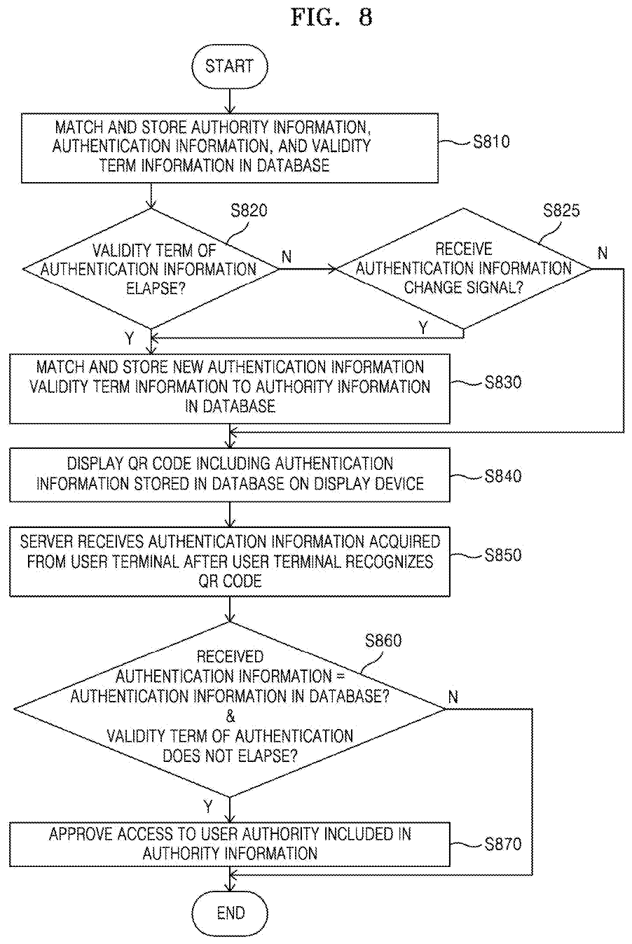

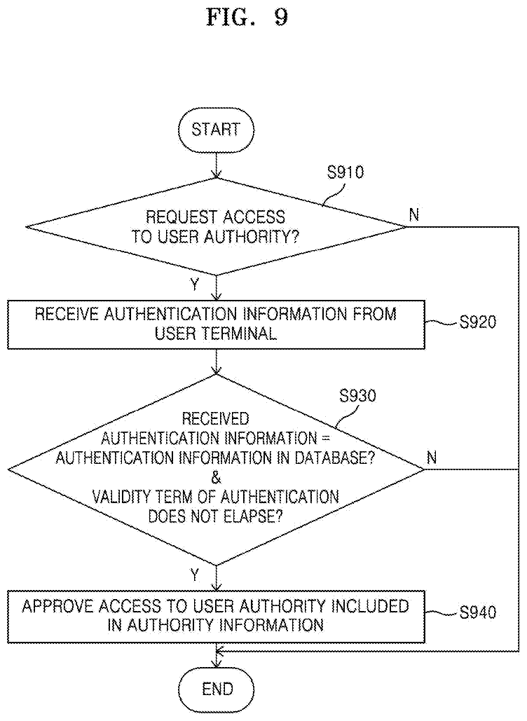

FIG. 8 is a flowchart illustrating a method of authenticating a user by using the system for authenticating a user for each zone of FIG. 1 according to another embodiment of the present invention and FIG. 9 is a flowchart illustrating a method of authenticating a user after user authentication is firstly approved as shown in FIG. 8.

Referring to FIGS. 1 through 8, the database management unit 210 may match and store the authority information including at least one user authority stored in each zone, the authentication information, and validity term information of the authentication information in the database 240, in operation S810. Then, the database management unit 210 determines whether the validity term of the authentication information elapses in operation S820. When the validity term of the authentication information elapses, new authentication information and new validity term information are matched to the authority information and may be stored in the database 240, in operation S830. Differently from operation S630, the authentication information, in which the existing validity term elapses, may not be deleted simultaneously with the elapse of the validity term, in operation S830. That is, the database 240 may store not only the valid authentication information, in which the validity term does not elapse, but also the authentication information, in which the validity term elapses. For example, as in FIG. 3, when the validity term of the authentication information 2222 which is matched to the authority information 1112 expires, the new authentication information 3333 may be matched to the authority information 1112 and stored in the database 240 while the authentication information 2222 which is matched to the authority information 1112 is not deleted, as in FIG. 5. When the server 110 receives the authentication information change signal from a manager server even if the validity term of the authentication information does not elapse in operation S820, the database management unit 210 may perform operation S830. That is, the authentication information change signal is used for a manager to enforcedly change the authentication information and thereby, the database management unit 210 changes the authentication information regardless of the validity term. The server 110 may receive the authentication information change signal as information to change the authentication information having the elapsed validity term to new authentication information. In this case, the database management unit 210 may perform operation S830 in response to the authentication information change signal so that the new authentication information may be matched to the authority information and stored in the database 240. When the new authentication information change signal is received even if the validity term elapses in operation S820, operation S830 may be performed, as operation S830 is performed regardless of the validity term.

The QR code generation unit 220 may display the QR code including the authentication information stored in the database 240 on the corresponding display device, in operation S840. For example, the database 240 may store information about the display devices each corresponding to the authority information in the database 240 as illustrated in FIGS. 3 through 5. In FIGS. 3 through 5, the QR code including the authentication information matched to authority information 1111 may be displayed on the display device 120_1 and the QR code including the authentication information matched to the authority information 1112 may be displayed on the display device 120_2. When the authentication information 2222 matched to the authority information 1112 is changed to the authentication information 3333, the QR code generation unit 220 may generate the QR code including the authentication information 3333 and display the QR code on the corresponding display device 120_2.

When the user terminal 130 recognizes the QR code displayed on the display device 120_2 and acquires the authentication information, the acquired authentication information is transmitted to the server 110 and the server 110 may receive the acquired authentication information, in operation S850. The determination unit 230 of the server 110 may determine whether the received authentication information exists in the database 240 and whether the validity term of the received authentication information elapses, in operation S860. When the authentication information that is identical with the received authentication information is stored in the database 240 and the validity term of the received authentication information does not elapse, the determination unit 230 may approve the user terminal 130 to access to the user authority included in the authority information corresponding to the authentication information, in operation S870. When the authentication information that is identical with the received authentication information is not stored in the database 240 or when the validity term elapses even if the received authentication information exists in the database 240, the determination unit 230 may disapprove the user terminal 130 to access to the user authority included in the authority information corresponding to the authentication information.

FIG. 8 illustrates that only authentication information is included in the QR code. However, in order to tighten up security, the QR code may include not only the authentication information but also the validity term information of the authentication information. In this case, when the user terminal 130 recognizes the QR code, the authentication information and the validity term information may be both acquired and the determination unit 230 may determine whether to approve an access to the user authority by using both received authentication information and validity term information.

After the user terminal 130 is firstly approved in FIG. 8, approval may be determined by using the acquired authentication information without recognizing the QR code by the user terminal 130 as in FIG. 9. The determination unit 230 may determine whether the user terminal 130 is to access to the user authority after the user terminal 130 is firstly approved, in operation S910. For example, when the user terminal 130 tries to access again to a web page used to access to the user authority after user authentication is approved, a request to access to the web page may be a user authority use request. As such, if an access to the user authority is requested, the determination unit 230 may receive the authentication information, which is previously acquired from the user terminal 130, from the user terminal 130, in operation S920. Then, the determination unit 230 determines whether the received authentication information exists in the database 240 and whether the validity term of the received authentication information elapses, in operation S930, and if it is determined that the received authentication information exists in the database 240 and the validity term of the received authentication information does not elapse, approves the user terminal 130 to access to the user authority, in operation S940.

In the system for authenticating a user for each zone according to the embodiments of the present invention, the user authority may be set for users by each term in a specific zone where users are continuously changed. Also, when the validity term elapses, an access to the user authority is disapproved. Accordingly, security may be maximized. In addition, when the QR code displayed on the display device corresponding to the applicable zone is recognized, even if a user does not place at a specific zone, the user authority relating to the applicable zone may be given for the validity term and thus, user convenience may be increased. Moreover, in the present invention, a user authentication process is performed again each time when the user authority is requested without recognizing the QR code after the QR code is firstly recognized and thereby, there is no need to recognize the QR code each time when the user authority is to be accessed. Furthermore, when the QR code is recognized, the present invention allows users an access to a web page used to access to the user authority. Accordingly, users may not need to install an application and a user authentication method having strengthened security may be provided while an additional installation process or a log-in process is omitted.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for authenticating a user for each zone which approves an access to at least one user authority set to each zone, the system comprising:
at least one display device for displaying QR codes that correspond to the at least one user authority set to each zone; and
a server for transmitting information about the QR codes to the display devices, receiving authentication information acquired after a user terminal recognizes the QR codes, and approving the user terminal to access to the user authority during only a validity term of the authentication information,
wherein the server comprises:
a database management unit for matching and storing authority information comprising at least one user authority set to each zone and authentication information, in which a validity term is set, in database, deleting the authentication information having elapsed validity term stored in the database simultaneously with the elapse of the validity term of the authentication information, matching new authentication information to the authority information, and storing the new authentication information in the database;
a QR code generation unit for displaying the QR codes comprising the authentication information stored in the database on the corresponding display devices; and
a determination unit for receiving the authentication information acquired from the user terminal after the user terminal recognizes the QR codes displayed on the display devices and approving the user terminal to access to the user authority included in the authority information that corresponds to the authentication information when the received authentication information exists in the database.

2. The system of claim 1, wherein when the user terminal tries to access to the user authority after the user terminal is firstly approved, the determination unit receives the authentication information, which is already acquired from the QR code by the user terminal, and approves the user terminal to access to the user authority included in the authority information that corresponds to the authentication information when the received authentication information exists in the database.

3. The system of claim 1, wherein when the user terminal is approved, the determination unit controls the user terminal to access to a web page used to access to the user authority.

4. The system of claim 2, wherein the database management unit matches and stores the authority information, the authentication information, and validity term information of the authentication information in the database and the determination unit approves the user terminal to access to the user authority included in the authority information that corresponds to the authentication information when the received authentication information exists in the database and a validity term of the authentication information does not elapse.

5. The system of claim 1, wherein the database management unit matches and stores the authority information, the authentication information, and validity term information of the authentication information in the database, the QR code generation unit displays the QR codes comprising the authentication information and the validity term information stored in the database on the corresponding display devices, and the determination unit approves the user terminal to access to the user authority included in the authority information that corresponds to the authentication information when the received authentication information exists in the database and the validity term according to the received of the validity term information does not elapse.

6. The system of claim 1, wherein when the database management unit receives an authentication information change signal used to change authentication information from a manager server, the database management unit deletes or changes at least one of the authentication information and the validity term information of the authentication information in response to the authentication information change signal, regardless of the elapse of the validity term of the authentication information stored in the database, and stores the deleted or changed authentication information and the validity term information in the database.

7. A system for authenticating a user for each zone which approves an access to at least one user authority set to each zone, the system comprising:
at least one display device for displaying QR codes that correspond to the at least one user authority set to each zone; and
a server for transmitting information about the QR codes to the display devices, receiving authentication information acquired after a user terminal recognizes the QR codes, and approving the user terminal to access to the user authority during only a validity term of the authentication information,
wherein the server comprises:
a database management unit for matching and storing authority information comprising at least one user authority set to each zone, authentication information, and validity term information of the authentication information, in which a validity term is set, in database and storing new authentication information and validity term information matched to the authority information in the database when the validity term of the authentication information elapses;
a QR code generation unit for displaying the QR codes comprising the authentication information stored in the database on the corresponding display devices; and
a determination unit for receiving the authentication information acquired from the user terminal after the user terminal recognizes the QR codes displayed on the display devices and approving the user terminal to access to the user authority included in the authority information that corresponds to the authentication information when the received authentication information exists in the database and the validity term of the authentication information does not elapse.

8. The system of claim 7, wherein when the user terminal tries to access to the user authority after the user terminal is firstly approved, the determination unit receives the authentication information, which is already acquired from the QR code by the user terminal, and approves the user terminal to access to the user authority included in the authority information that corresponds to the authentication information when the received authentication information exists in the database and the validity term of the authentication information does not elapse.

9. The system of claim 7, wherein when the user terminal is approved, the determination unit controls the user terminal to access to a web page used to access to the user authority.

10. The system of claim 7, wherein the database management unit does not delete the authentication information having elapsed validity term stored in the database simultaneously with the elapse of the validity term of the authentication information and stores new authentication information and validity term information matched to the authority information in the database.

11. The system of claim 7, wherein the QR code generation unit displays the QR codes comprising the authentication information and the validity term information stored in the database on the corresponding display devices, and the determination unit approves the user terminal to access to the user authority included in the authority information that corresponds to the authentication information when the received authentication information exists in the database and the validity term according to the received of the validity term information does not elapse.

12. The system of claim 7, wherein when the database management unit receives an authentication information change signal used to change authentication information from a manager server, the database management unit deletes or changes at least one of the authentication information and the validity term information of the authentication information in response to the authentication information change signal, regardless of the elapse of the validity term of the authentication information stored in the database, and stores the deleted or changed authentication information and the validity term information in the database.
